(19) United States
(12) Patent Application Publication
(10) Pub. No.: US 2007/0026123 A1
(43) Pub. Date: Feb. 1, 2007

(54) Pesto products

(76) Inventor: Lauren Stewart, Rego Park, NY (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/194,336

(22) Filed: Aug. 1, 2005

(51) Int. Cl. A23L 1/40

(52) U.S. Cl. 426/589

(57) ABSTRACT

The present invention provides improved pesto products. Formulations or recipes and processes for making the pesto products are provided. A ready-made pesto is also provided. The present invention also provides unique methods of storing and applying the pesto products.

### FIELD OF THE INVENTION

The present invention is related to food products, particularly, to novel and/improved pesto products, particularly, to formulations/ingredients and processes for making the pesto products.

### BACKGROUND THE INVENTION

The original pesto is an Italian sauce or dressing which is generally a concoction made of basil, garlic, pine nuts, cheese and olive oil as main ingredients. The origins of pesto are uncertain. However, some studies revealed that people in the Liguria region of Northern Italy, particularly the city of Genoa, might have created the earliest version of pesto as a dressing called “battuto d'aglio” (literally battered garlic) or “pesto alla Genovese” during Roman times. Other studies proposed that pesto probably originated from the northern coasts of Africa. The ancient method of preparing pesto employs a marble mortar and the pestle.

Pesto is traditionally used on breads or tossed with pasta. It is sometimes used as a seasoning for other dishes. Today, pesto is becoming more and more popular on the tables of the dining rooms or restaurants in the U.S. and all over the world.

There is a need to develop pesto formulations with new and improved quality, taste and flavors, as well as novel and improved process for making such pestos compositions.

### SUMMERY OF THE INVENTION

The present invention provides novel and improved pesto products. In a particular aspect, the present invention provides “ready-to-eat” or “ready-made” pestos.

In one aspect, the present invention provides novel and improved pesto formulations. In a particular aspect, a pesto formulation of the present invention has a novel or unique and improved taste or flavor. In another particular aspect, a pesto formulation of the present invention has a decorative effect for foods or dishes. A particular pesto formulation of the present invention is a pumpkin chilpolte pesto.

In another aspect, the present invention provides novel and improved methods of making the pesto products.

In still another aspect, the present invention provides method of serving or applying pestos to achieve a unique and improved flavor.

In yet another aspect, the present invention provides a method of decorating foods or dishes with at least one type of pesto formulation of the present invention.

### DETAILED DESCRIPTION OF THE INVENTION

In one embodiment, the present invention provides novel and improved pesto products.

By “pesto” or “pesto products” or “pesto formulations” is meant sauces or dressings that are used to create a unique flavor, taste, and/or decoration for food or dishes. Pesto products of the present invention are not limited to bread, dressing or pasta tosses but can also be served with variety of dishes including, but not limited to, chicken, seafood (e.g., fish, shellfish, shrimp, or lobster), vegetables, rice, lamb, veal, pork, beef, crostini, flatbread or tortilla. A pesto product of the present invention can be served on its own or in combination with one or more pesto products of the present invention. The pesto products of the present invention can be placed on top of, or tossed with, the food or a dish.

According to the present invention, a pesto product of the present invention is achieved by the combination of certain main ingredients, which are preferably commercially available food products, and specific additives. The present invention provides processes for the preparation of the pesto formulation which provides a unique taste and flavor.

The main ingredients of the pestos contemplated by the present invention comprise basil or arugula, garlic, food oil, cheese and nuts. Preferably, olive oil, pine nuts, walnuts, and smoked almonds are used in accordance with the present invention. The additive(s) of the present invention include, but are not limited to, pumpkin, pepper, strawberry, blueberry, papaya, mango, mint, coconut, peach, pomegranate, fig, pineapple, pecan, apple, caper, pear, and/or cherry. The use of such additives in combination with the main ingredient was heretofore unappreciated and provides an unexpectedly pleasing and improved pesto formulation.

By “additive” is meant a food product, preferably, fruit or fruit products, nuts, spices and/or plant components which are added to pesto main ingredients to form a formulation that constitutes a unique taste or flavor of the pesto. According to the present invention, a pesto traditionally contains one kind of additive. However, the present invention contemplates a pesto formulation that contains at least two or more kinds of additives, that impart an improved flavor, consistency mouthfeel and taste.

In one embodiment, the present invention is directed to a pesto product comprising substantially mixed or blended main ingredients and additive(s). In another embodiment, the present invention is directed to a pesto product made by a process comprising providing or preparing each of the main ingredients and additive(s) and mixing or blending the prepared main ingredient and additive, preferably, one by one, until each item is completely blended.

The pestos of the present invention can be utilized as a garnish/accoutrement for seafood, chicken, and beef dishes; can be tossed with all pasta's, rice, and cooked vegetables, as the principal ingredient of flavor infusion; as a spread, on a tortilla, flatbread, Italian bread, French bread, panini sandwiches, and as well, as a dip for crackers, crostini, and raw vegetables.

According to the present invention, a pesto product of the present invention can be made in a food processor of any kind or design, preferably a food processor having a capacity of 7 or more cups, preferably, about 11-14 cups, more preferably, a large (i.e., a capacity of about 14 cups) Cuisinart® food processor. The product can be served instantly or refrigerated for up to 2 months, preferably, up to two weeks, or frozen for up to 12 months, preferably, up to three months for maintaining sufficient freshness and a unique taste and/or flavor.

According to the present invention, the pesto products can be heated but not overheated by any means, e.g., in a microwave (on high heat alone) or on a hot stovetop with pasta. Preferably, the pesto products contemplated by the present invention are tossed with warm pasta, spread on hot chicken, fish, shellfish, warm breads or crostinis, tortilla, or warm rice. In a particular embodiment of the present invention, the pestos can be heated, e.g., over low heat in a microwave or low heat on the stovetop, only after tossing with or spreading on food or dishes. Preferably, the pesto products of the present invention can be heated to about 200-250° F.

In a preferred embodiment, the present invention provides a pumpkin chilpolte pesto product, comprising basil or arugula, garlic, pine nuts or walnuts, olive oil, parmesan/parmesan/reggiano cheese or asiago, pepper, pumpkin or pumpkin derived products. Preferably, the product further comprises salt, sugar, and/or nutmeg. Preferably, garlic is in the form of garlic cloves. Cheese can be shredded or grated. A salt in any form is contemplated by the present invention, e.g., nu-salt™, kosher salt, iodized salt, sea salt, salt substitute or regular salt. Pepper used in this product can be black, white, or red pepper, or combinations thereof. Preferably, both black or white pepper and red pepper are used. Sugar contemplated by the present invention includes, but is not limited to, Splenda™, Nutrasweet™, Stevia™, honey, brown sugar, or cane sugar (e.g., Turbinado or Sugar In The Raw). A “pumpkin derived product” is meant a food product that is made of pumpkin ingredients, which may or may not contain other ingredients. For example, a preferred pumpkin derived product is pumpkin pie spice, which is a combination of cinnamon, nutmeg, ginger, allspice and sulfating agents.

The preferred formulation, “Pumpkin Chilpotle Pesto” does not exist within the current market place. The flavor and textures of this pesto product are hearty, earthy, smoky, pungent, and the consistency more viscous, than that of the pestos available in the prior art.

Another embodiment of the present invention is directed to a pumpkin chilpolte pesto product made by a process, comprising
a) providing about 3-5 cups, preferably, about 4 cups, of basil or arugula, preferably, washed, patted dry and tightly packed; tightly packed, leaf, by leaf, one on top of the other, in a measuring cup of appropriate size.
b) providing about 8-10, preferably, about 9 small to medium garlic cloves, minced and left to breathe for a short period of time, preferably, about 1 to 10 minutes, more preferably, about 5 minutes, prior to adding about 1-3 cups, preferably, about 2 cups, of nuts, preferably, pine nuts or walnuts;
c) providing about 0.5 to 2 cups, preferably, about 1 cup, of olive oil;
d) providing about 1-3 cups, preferably, about 2 cups, of cheese, preferably, grated or shredded parmesan or parmesan/reggiano cheese or same amount of shredded asiago;
e) providing an appropriate amount of pepper or any other pepper derived product, e.g., hot sauce, for desired taste or flavor, e.g., ½ of a teaspoon of black or white pepper and/or ½ teaspoon of red pepper flakes, or hot sauce;
f) providing about 0.5 to about 1 teaspoon, preferably, about 0.5 teaspoon, of pumpkin or pumpkin derived product, preferably, ½ teaspoon of pumpkin pie spice (which is a combination of cinnamon, nutmeg, ginger, allspice and sulfating agents);
g) completely mixing the components or ingredients obtained from steps a) to f) by combining the components or ingredients provided by steps a) to f), preferably, in a food processor, more preferably, one at a time in the food processor until each item is completely mixed or blended by the food processor.

By “completely mixed or blended” is meant the combining or mixing or associating the ingredients, constituents or components until the separate ingredients or constituents or components, e.g., the main ingredients and additive(s) described above, cannot be distinguished.

In a particularly preferred embodiment, the ingredients of the pumpkin chilpotle pesto product further comprise at least one of the following components:
a) about 0.5 to about 1 teaspoon, preferably, about 0.5 teaspoon of nu-salt™, kosher salt, iodized salt, sea salt, salt substitute or regular salt;
b) about 0-1 teaspoon, preferably, ¼ teaspoon of grated nutmeg;
c) about 0.5 to about 1 teaspoon, preferably, about 0.5 teaspoon of sugar including, but not limited to Splenda™, Nutrasweet™, Stevia™, honey, brown sugar, or cane sugar (e.g., Turbinado or Sugar In The Raw);
d) about 1-3, preferably, about 2 chilpolte peppers in adobo sauce. Chilpotle Peppers are sold this way in a can. The sauce only coats the pepper; no additional sauce necessary.
e) about 1 can 15 oz or 425 grams of pure pumpkin or 1 can 15 oz of spiced pumpkin

According to the present invention, when adding the oil for blending or mixing, oil should be allowed to stream into the mixture slowly to ensure a complete mixing or blending. The pumpkin chilpolte pesto product obtained by the process above can have a serving size within the ken of the ordinary skilled artisan such as about 35-55 ounces and preferably 44 ounces.

In a particular embodiment, a pesto product of the present invention can be made as “ready-to-eat” or “ready-made” products, e.g., in the form of a packed sauces or dressings in grocery stores or specialty food shops.

By “ready-to-eat” or “ready-made” is meant a commercially available product that is made beforehand, particularly, for general sale, which is ready to consume.

One embodiment of the present invention provides a method of preparing a pesto product, comprising providing or preparing each of the main ingredients and additive(s), mixing or blending the prepared main ingredients and additive(s), preferably, one by one, until each item is completely mixed or blended, i.e., until the separate ingredients or constituents and additive(s) cannot be distinguished.

Another embodiment of the present invention provides a method for preparing pumpkin chilpolte pesto, comprising,
a) providing about 3-5 cup of basil or arugula;
b) providing about 8-10 small to medium garlic cloves, minced and left to breath for a short period of time before adding about 1-3 cups of pine nuts or walnuts;
c) providing about 0.5 to 2 cups of olive oil;
d) providing about 1-3 cups of cheese;
e) providing an appropriate amount, preferably, about 0.5 to about 2 teaspoon, more preferably, about 0.5 to about 1 teaspoon, of pepper or any other pepper derived product;
f) providing about 0.5 to about 1 teaspoon pumpkin or pumpkin derived product;
g) combining all the ingredients of a) to f) in a food processor until each item is completely blended.

In a particular embodiment, the present invention provides a process of preparing pumpkin chilpolte pesto, comprising
a) providing about 4 cups of washed, patted dry and tightly packed fresh basil leaves or arugula;
b) providing about 9 small to medium garlic cloves, minced and left to breath for about 5 minutes before adding about 2 cups of pine nuts or walnuts;
c) providing about 1 cup of olive oil;
d) providing about 2 cups of grated or shredded cheese;
e) providing about 0.5 teaspoon salt;
f) providing about 1 of a teaspoon of black or white pepper
g) providing about 12 teaspoon of red pepper flakes or hot sauce;
h) providing about 0.5 teaspoon of pumpkin pie spice;
i) providing about ¼ teaspoon of grated nutmeg;
j) about 0.5 teaspoon of sugar;
k) providing about 2 chilpotle peppers coated with adodo sauce;
l) providing about 1 can 15 oz or 425 grams of pure pumpkin or 1 can 15 oz of spiced pumpkin
m) combining all ingredients or components obtained from steps a) to l), preferably, in a food processor, one at a time, until each item is completely mixed or blended.

In still another embodiment, the present invention is directed to a method of serving or applying the pesto product, comprising preparing the product as described above, optionally storing the product in a refrigerated or frozen condition, applying or spreading the product on, or tossing the product with, the food or dishes, and optionally heating the food/dish with the pesto, e.g., over low heat in a microwave. The pesto of the present invention should avoid overheating by any means, e.g., by heating in a microwave on high heat alone or on a hot stovetop with pasta. In a particular embodiment, the product can be tossed with warm pasta, spread on hot chicken, fish, shellfish, warm breads or crostinis, tortilla and/or warm rice, prior to being heated.

In yet another embodiment, the present invention provides a method of decorating foods or dishes comprising obtaining at least one type of pesto of the present invention and decorating the food or dishes with the obtained pesto(s).

By “decorate food or dishes” is meant furnishing food or dishes with ornamental effects by one or more pestos, preferably, in addition to the pestos' unique flavor and/or taste. In a particular embodiment, decorated food or dishes according to the present invention have added economic or commercial values relative to the combined value of the food and the pesto.

The present invention further provides the following non-limiting examples.

### EXAMPLE 1

### Pumpkin Chilpolte Pesto

2-4 cups of fresh basil leaves or arugula washed, patted dry and tightly packed
3-9 small to medium garlic cloves, minced and left to breathe for about 5 minutes before adding
½-2 cups of pine nuts or walnuts
¼-1 cup of extra virgin, light or regular olive oil
1-2 cups of grated or shredded parmesan or parmesan/reggiano cheese or same amount of shredded asiago
⅛-½ teaspoon of nu-salt™, kosher salt, iodized salt, sea salt, salt substitute or regular salt
⅛-½ of a teaspoon of black or white pepper
⅛-½ teaspoon of red pepper flakes, or hot sauce
⅛-½ teaspoon of pumpkin pie spice (which is a combination of cinnamon, nutmeg, ginger, allspice and sulfating agents)
⅛-¼ teaspoon of grated nutmeg
⅛-½ of a teaspoon of Splenda™, Nutrasweet™, Stevia™, honey, brown sugar, or cane sugar (e.g., Turbinado or Sugar In The Raw)
1-2 chilpolte peppers coated with adobo sauce
1 can 15 oz or 425 grams of pure pumpkin or 1 can 15 oz of spiced pumpkin
Combine all ingredients in a food processor; one at a time, until each item is completely blended. When adding the oil allow it to stream in slowly to insure a complete blending.

### EXAMPLE 2

### Strawberry Pesto

1-2 cups of basil leaves or arugula washed, patted dry and tightly packed
2-4 small to medium cloves of garlic (minced and left to breathe for about 5 minutes before adding)
⅛-1 cup of pine nuts or walnuts
⅛-½ cup of extra virgin light or regular olive oil
½-1 cup of grated or shredded parmesan or parmesan/reggiano cheese or same amount of shredded asiago
⅛-½ cup of fresh or frozen strawberries
⅛-¼ teaspoon of nu-salt, salt substitute, or regular salt
⅛-¼ of a teaspoon of black or white pepper
⅛-¼ teaspoon of red pepper flakes, or hot sauce
⅛-¼ teaspoon of grated nutmeg or pumpkin pie spice
0.005-0.035 ounces of splenda, nutrasweet, stevia, honey or sugar
Combine all ingredients in a food processor; one at a time, until each item is completely blended. When adding the oil allow it to stream in slowly to insure a complete blending.

### EXAMPLE 3

### Blueberry Pesto

1-2 cups of basil leaves or arugula washed, patted dry and tightly packed
2-4 small to medium cloves of garlic (minced and left to breathe for about 5 minutes before adding)
½-1 cup of pine nuts or walnuts
⅛-½ cup of extra virgin light or regular olive oil
½-1 cup of grated or shredded parmesan or parmesan/reggiano cheese or same amount of shredded asiago
⅛-¼ cup of fresh or frozen blueberries
⅛-¼ teaspoon of nu-salt, salt substitute, or regular salt
⅛-¼ of a teaspoon of black or white pepper
⅛-¼ teaspoon of red pepper flakes, or hot sauce
⅛-¼ teaspoon of grated nutmeg or pumpkin pie spice
0.005-0.035 ounces of splenda, nutrasweet, stevia, honey or sugar
Combine all ingredients in a food processor; one at a time, until each item is completely blended. When adding the oil allow it to stream in slowly to insure a complete blending.

### EXAMPLE 4

### Papaya Pesto

⅛-1 cup of basil leaves or arugula washed, patted dry and tightly packed
1-2 small to medium cloves of garlic (minced and left to breath for 5 minutes before adding)
⅛-½ cup of pine nuts or walnuts
⅛-¼ cup of extra virgin light or regular olive oil
⅛-½ cup of grated or shredded parmesan or parmesan/reggiano cheese or same amount of shredded asiago
⅛-1 cup of fresh, frozen, or dried papaya
⅛-¼ teaspoon of nu-salt, salt substitute, or regular salt
⅛-¼ of a teaspoon of black or white pepper
⅛-½ of 0.005-0.035 ounces of splenda, nutrasweet, stevia, honey or sugar
Combine all ingredients in a food processor; one at a time, until each item is completely blended. When adding the oil allow it to stream in slowly to insure a complete blending.

### EXAMPLE 5

### Mango Pesto

⅛-1 cup of basil leaves or arugula washed, patted dry and tightly packed
1-2 small to medium cloves of garlic (minced and left to breathe for about 5 minutes before adding)
⅛-½ cup of pine nuts or walnuts
⅛-¼ cup of extra virgin light or regular olive oil
⅛-½ cup of grated or shredded parmesan or parmesan/reggiano cheese or same amount of shredded asiago
⅛-1 cup of fresh, frozen or dried mango
⅛-¼ teaspoon of nu-salt, salt substitute, or regular salt
⅛-¼ of a teaspoon of black or white pepper
⅛-½ of 0.005-0.035 ounces of splenda, nutrasweet, stevia, honey or sugar
⅛-½ of a squeezed lime or ½ teaspoon of lime concentrate
Combine all ingredients in a food processor; one at a time, until each item is completely blended. When adding the oil allow it to stream in slowly to insure a complete blending.

### EXAMPLE 6

### Mint Pesto

⅛-1 cup of basil leaves or arugula washed, patted dry and tightly packed
1-2 small to medium cloves of garlic (minced and left to breathe for about 5 minutes before adding)
⅛-½ cup of pine nuts or walnuts
⅛-¼ cup of extra virgin light or regular olive oil
⅛-½ cup of grated or shredded parmesan or parmesan/reggiano cheese or same amount of shredded asiago
⅛-¼ cup of fresh mint well washed
Dash of clove
⅛-¼ teaspoon of nu-salt, salt substitute, or regular salt
⅛-¼ of a teaspoon of black or white pepper
⅛-½ of 0.005-0.035 ounces of splenda, nutrasweet, stevia, honey or sugar
Combine all ingredients in a food processor; one at a time, until each item is completely blended. When adding the oil allow it to stream in slowly to insure a complete blending.

### EXAMPLE 7

### Coconut Pesto

⅛-1 cup of basil leaves or arugula washed, patted dry and tightly packed
1-2 small to medium cloves of garlic (minced and left to breathe for about 5 minutes before adding)
⅛-½ cup of pine nuts or walnuts
⅛-¼ cup of extra virgin light or regular olive oil
⅛-½ cup of grated or shredded parmesan or parmesan/reggiano cheese or same amount of shredded asiago
⅛-1 cup of shredded sweetened or unsweetened coconut
⅛-¼ teaspoon of nu-salt, salt substitute, or regular salt
⅛-¼ of a teaspoon of black or white pepper
⅛-½ of 0.005-0.035 ounces of splenda, nutrasweet, stevia, honey or sugar
Combine all ingredients in a food processor; one at a time, until each item is completely blended. When adding the oil allow it to stream in slowly to insure a complete blending.

### EXAMPLE 8

### Peach Pesto

⅛-1 cup of basil leaves or arugula washed, patted dry and tightly packed
1-2 small to medium cloves of garlic (minced and left to breathe for about 5 minutes before adding)
⅛-½ cup of pine nuts or walnuts
⅛-¼ cup of extra virgin light or regular olive oil
⅛-½ cup of grated or shredded parmesan or parmesan/reggiano cheese or same amount of shredded asiago
1-2 small peaches decored or 1 cup of canned or frozen peaches
⅛-¼ teaspoon of nu-salt, salt substitute, or regular salt
⅛-¼ of a teaspoon of black or white pepper
⅛-½ of 0.005-0.035 ounces of splenda, nutrasweet, stevia, honey or sugar
Combine all ingredients in a food processor; one at a time, until each item is completely blended. When adding the oil allow it to stream in slowly to insure a complete blending.

### EXAMPLE 9

### Pomegranate Pesto

⅛-1 cup of basil leaves or arugula washed, patted dry and tightly packed
1-2 small to medium cloves of garlic (minced and left to breathe for about 5 minutes before adding)
⅛-½ cup of pine nuts or walnuts
⅛-¼ cup of extra virgin light or regular olive oil
⅛-½ cup of grated or shredded parmesan or parmesan/reggiano cheese or same amount of shredded asiago
⅛-½ cup of pomegranate
⅛-¼ teaspoon of nu-salt, salt substitute, or regular salt
⅛-¼ of a teaspoon of black or white pepper
⅛-½ of 0.005-0.035 ounces of splenda, nutrasweet, stevia, honey or sugar
⅛-¼ teaspoon of grated nutmeg or pumpkin pie spice
Combine all ingredients in a food processor; one at a time, until each item is completely blended. When adding the oil allow it to stream in slowly to insure a complete blending.

### EXAMPLE 10

### Fig Pesto

⅛-1 cup of basil leaves or arugula washed, patted dry and tightly packed
1-2 small to medium cloves of garlic (minced and left to breathe for about 5 minutes before adding)
⅛-½ cup of pine nuts or walnuts
⅛-¼ cup of extra virgin light or regular olive oil
⅛-½ cup of grated or shredded parmesan or parmesan/reggiano cheese or same amount of shredded asiago
⅛-¼ cup of figlets (small figs)
⅛-¼ teaspoon of nu-salt, salt substitute, or regular salt
⅛-¼ of a teaspoon of black or white pepper
⅛-½ of 0.005-0.035 ounces of splenda, nutrasweet, stevia, honey or sugar
⅛-¼ teaspoon of grated nutmeg or pumpkin pie spice
⅛-¼ teaspoon of red pepper flakes, or hot sauce
Combine all ingredients in a food processor; one at a time, until each item is completely blended. When adding the oil allow it to stream in slowly to insure a complete blending.

### EXAMPLE 11

### Caramelized Pineapple and Arugula Pesto

⅛-1 cup of basil leaves or arugula washed, patted dry and tightly packed
2 small to medium cloves of garlic (minced and left to breathe for about 5 minutes before adding)
⅛-½ cup of pine nuts, walnuts, or pecans
¼ cup of extra virgin light or regular olive oil
⅛-½ cup of grated or shredded parmesan or parmesan/reggiano cheese or same amount of shredded asiago
⅛-¾ cup grilled pineapple
⅛-¼ teaspoon of nu-salt, salt substitute, or regular salt
⅛-¼ of a teaspoon of black or white pepper
⅛-¼ teaspoon of red pepper flakes, or hot sauce
Combine all ingredients in a food processor; one at a time, until each item is completely blended. When adding the oil allow it to stream in slowly to insure a complete blending.

### EXAMPLE 12

### Arugula, Gorgonzola and Pecan Pesto

½-1 cup of basil leaves or arugula washed, patted dry and tightly packed
1-2 small to medium cloves of garlic (minced and left to breathe for about 5 minutes before adding)
⅛-½ cup of pine nuts, walnuts, or pecans
⅛-¼ cup of extra virgin light or regular olive oil
⅛-½ cup of grated or shredded parmesan or parmesan/reggiano cheese or same amount of shredded asiago
¼-⅓ cup of crumbled gorgonzola or blue cheese
⅛-¼ teaspoon of nu-salt, salt substitute, or regular salt
⅛-¼ of a teaspoon of black or white pepper
⅛-¼ teaspoon of red pepper flakes, or hot sauce
Combine all ingredients in a food processor; one at a time, until each item is completely blended. When adding the oil allow it to stream in slowly to insure a complete blending.

### EXAMPLE 13

### Arugula, Asiago and Proscuitto Pesto

½-1 cup of basil leaves or arugula washed, patted dry and tightly packed
1-2 small to medium cloves of garlic (minced and left to breathe for about 5 minutes before adding)
⅛-½ cup of pine nuts, walnuts, pecans, or smoked almonds
⅛-¼ cup of extra virgin light or regular olive oil
⅛-½ cup of grated or shredded parmesan or parmesan/reggiano cheese or same amount of shredded asiago
⅛-¼ cup of cut up proscuitto
⅛-¼ of a teaspoon of black or white pepper
⅛-½ teaspoon of red pepper flakes, or hot sauce
Combine all ingredients in a food processor; one at a time, until each item is completely blended. When adding the oil allow it to stream in slowly to insure a complete blending.

### EXAMPLE 14

### Cinnamon and Brown sugar Pesto w/or with out Crumbled Sweet Turkey Sausage

½-1 cup of basil leaves or arugula washed, patted dry and tightly packed
1-2 small to medium cloves of garlic (minced and left to breathe for about 5 minutes before adding)
⅛-½ cup of pine nuts, walnuts, or pecans
⅛-¼ cup of extra virgin light or regular olive oil
⅛-½ cup of grated or shredded parmesan or parmesan/reggiano cheese or same amount of shredded asiago
⅛-1 tablespoon of grated cinnamon
⅛-1 tablespoon of brown sugar, dark or light with or without sugar
⅛-1 browned turkey sweet sausage, taken out of the casing, and crumbled (about 4 to 6 ounces)
⅛-¼ of a teaspoon of black or white pepper
⅛-½ teaspoon of red pepper flakes, or hot sauce
Combine all ingredients in a food processor; one at a time, until each item is completely blended. When adding the oil allow it to stream in slowly to insure a complete blending.

### EXAMPLE 15

### Apple, Pecan, Asiago Pesto

½-1 cup of basil leaves or arugula washed, patted dry and tightly packed
1-2 small to medium cloves of garlic (minced and left to breathe for about 5 minutes before adding)
⅛-½ cup of pine nuts, walnuts, or pecans
⅛-¼ cup of extra virgin light or regular olive oil
⅛-½ cup of grated or shredded parmesan or parmesan/reggiano cheese or same amount of shredded asiago
½-1 cup of sweetened or unsweetened applesauce
⅛-¼ of a teaspoon of black or white pepper
⅛-½ teaspoon of red pepper flakes, or hot sauce
⅛-½ of 0.005-0.035 ounces of splenda, nutrasweet, stevia, honey or sugar
Combine all ingredients in a food processor; one at a time, until each item is completely blended. When adding the oil allow it to stream in slowly to insure a complete blending.

### EXAMPLE 16

### Arugula, Feta, and Caper Pesto

½-1 cup of basil leaves or arugula washed, patted dry and tightly packed
1-2 small to medium cloves of garlic (minced and left to breathe for bout 5 minutes before adding)
⅛-½ cup of pine nuts, walnuts, or pecans
⅛-¼ cup of extra virgin light or regular olive oil
⅛-½ cup of grated or shredded parmesan or parmesan/reggiano cheese or same amount of shredded asiago
¼-⅓ cup of fat free, reduced fat, or non fat feta cheese
1-2 tablespoons of capers
⅛-¼ of a teaspoon of black or white pepper
⅛-½ teaspoon of red pepper flakes, or hot sauce
Combine all ingredients in a food processor; one at a time, until each item is completely blended. When adding the oil allow it to stream in slowly to insure a complete blending.

### EXAMPLE 17

### Arugula, Gorgonzola, and Pear Pesto

½-1 cup of basil leaves or arugula washed, patted dry and tightly packed
1-2 small to medium cloves of garlic (minced and left to breathe for about 5 minutes before adding)
⅛-¼ cup of extra virgin light or regular olive oil
⅛-½ cup of grated or shredded parmesan or parmesan/reggiano cheese or same amount of shredded asiago
¼-⅓ cup of gorgonzola or blue cheese
¼-¾ cup of canned sweetened or unsweetened pears
⅛-¼ of a teaspoon of black or white pepper
⅛-½ teaspoon of red pepper flakes, or hot sauce
⅛-½ of 0.005-0.035 ounces of splenda, nutrasweet, stevia, honey or sugar
⅛-¼ teaspoon of grated nutmeg or pumpkin pie spice
Combine all ingredients in a food processor; one at a time, until each item is completely blended. When adding the oil allow it to stream in slowly to insure a complete blending.

### EXAMPLE 18

### Arugula Pesto with Bing Cherry and Gorgonzola

½-1 cup of basil leaves or arugula washed, patted dry and tightly packed
1-2 small to medium cloves of garlic (minced and left to breathe for about 5 minutes before adding)
⅛-½ cup of pine nuts, walnuts, or pecans
⅛-¼ cup of extra virgin light or regular olive oil
⅛-½ cup of grated or shredded parmesan or parmesan/reggiano cheese or same amount of shredded asiago
¼-⅓ cup of gorgonzola or blue cheese
⅛-½ cup of fresh, pitted cherries, frozen cherries, or 1/3 cup of dried cherries
⅛-¼ of a teaspoon of black or white pepper
⅛-½ teaspoon of red pepper flakes, or hot sauce
⅛-½ of 0.005-0.035 ounces of splenda, nutrasweet, stevia, honey or sugar
Combine all ingredients in a food processor; one at a time, until each item is completely blended. When adding the oil allow it to stream in slowly to insure a complete blending.

What is claimed is:

1. A pumpkin chilpolte pesto product produced by a process, comprising
a) providing about 3-5 cups of basil or arugula;
b) providing about 8-10 small to medium garlic cloves, minced and left to breath for a short period of time before adding about 1-3 cups of pine nuts or walnuts;
c) providing about 0.5 to 2 cups of olive oil;
d) providing about 1-3 cups of cheese;
e) providing about 0.5-1 teaspoons of pepper or any other pepper derived product;
f) providing about 0.5 to about 1 teaspoon pumpkin or pumpkin derived product;
g) combining ingredients obtained from steps a) to f) in a food processor until each item is completely blended.

2. The product of claim 1, wherein the process further comprises one or more steps prior to the combining step, wherein the steps comprise a) providing about 0.5 to about 1 teaspoon salt; b) providing about 0-1 teaspoon grated nutmeg; c) providing about 0.5 to about 1 teaspoon sugar; d) providing about 1-3 chilpotle peppers; or e) providing about 1 can of 15 oz or 425 grams of pure pumpkin or 1 can of 15 oz of spiced pumpkin.

3. The product of claim 1, wherein the process comprises
a) providing about 4 cups of washed, patted dry and tightly packed fresh basil leaves or arugula;
b) providing about 9 small to medium minced garlic cloves, and about 2 cups of pine nuts or walnuts;
c) providing about 1 cup of olive oil;
d) providing about 2 cups of grated or shredded cheese;
e) providing about 0.5 teaspoon salt;
f) providing about ½ of a teaspoon of black or white pepper
g) providing about ½ teaspoon of red pepper flakes or hot sauce;
h) providing about 0.5 teaspoon of pumpkin pie spice;
i) providing about ¼ teaspoon of grated nutmeg;
j) about 0.5 teaspoon of sugar;
k) providing about 2 chilpolte peppers coated in adobo sauce;
l) providing about 1 can 15 oz or 425 grams of pure pumpkin or 1 can 15 oz of spiced pumpkin
m) combining all ingredients of a) to l) in a food processor one at a time, until each item is completely blended.

4. The method of claim 1 further comprising one or more steps prior to the combining step, wherein the steps comprise a) providing about 0.5 to about 1 teaspoon salt; b) providing about 0-1 teaspoon grated nutmeg; c) providing about 0.5 to about 1 teaspoon sugar; d) providing about 1-3 chilpolte peppers; or e) providing about 1 can 15 oz or about 425 grams of pure pumpkin or 1 can 15 oz of spiced pumpkin.

5. A pumpkin chilpolte pesto product, comprising basil or arugula, garlic, nuts, olive oil, cheese, pepper, pumpkin or pumpkin derived products.

6. The product of claim 5 further comprising one or more ingredients selected from the group consisting of salt, sugar, or nutmeg.

7. The product of claim 5, wherein the cheese is grated or shredded parmesan/parmesan/reggiano cheese or shredded asiago.

8. The product of claim 5, wherein the pepper is selected from the group consisting of black pepper, white pepper, red pepper and chilpolte pepper.

9. The product of claim 5, wherein the pumpkin derived product is pumpkin pie spice, which is a combination of cinnamon, nutmeg, ginger, allspice and sulfating agents.

10. The product of any one of claims 1-9, wherein the product is a ready-made product.

11. A process for preparing pumpkin chilpolte pesto, comprising,
a) providing about 3-5 cups of basil or arugula;
b) providing about 8-10 small to medium garlic cloves, minced and left to breath for a short period of time before adding about 1-3 cups of pine nuts or walnuts;
c) providing about 0.5 to 2 cups of olive oil;
d) providing about 1-3 cups of cheese;
e) providing about 0.5 to about 2 teaspoon pepper or any other pepper derived product;
f) providing about 0.5 to about 1 teaspoon pumpkin or pumpkin derived product;
g) combining ingredients obtained from steps a) to f) in a food processor one at a time until each item is completely blended.

12. The process of claim 11, further comprising:
a) providing about 4 cups of washed, patted dry and tightly packed fresh basil leaves or arugula;
b) providing about 9 small to medium minced garlic cloves, and about 2 cups of pine nuts or walnuts;
c) providing about 1 cup of olive oil;
d) providing about 2 cups of grated or shredded cheese;
e) providing about 0.5 teaspoon salt;
f) providing about ½ of a teaspoon of black or white pepper
g) providing about ½ teaspoon of red pepper flakes or hot sauce;
h) providing about 0.5 teaspoon of pumpkin pie spice;
i) providing about ¼ teaspoon of grated nutmeg;
j) about 0.5 teaspoon of sugar;
k) providing about 2 chilpotle peppers coated in adobo sauce; and
l) providing about 1 can of 15 oz or 425 grams of pure pumpkin or 1 can of 15 oz of spiced pumpkin.

13. A method of decorating food or dishes, comprising obtaining one or more of pesto products and decorating the food or dishes with the obtained pesto products.

14. The method of claim 13, wherein the pesto is the product of claim 1.
